(19) United States
(12) Patent Application Publication
(10) Pub. No.: US 2024/0055697 A1
(43) Pub. Date: Feb. 15, 2024

(54) BATTERY COOLING SYSTEM

(71) Applicant: GENTHERM INCORPORATED, Northville, MI (US)

(72) Inventor: Michael Peter CIACCIO, Chelsea, MI (US)

(21) Appl. No.: 18/266,893

(22) PCT Filed: Dec. 21, 2021
(86) PCT No.: PCT/US2021/064510

§ 371 Date: Jun. 13, 2023

Related U.S. Application Data
(60) Provisional application No. 63/131,450, filed on Dec. 29, 2020.

(51) Int. Cl. H01M 10/6569; H01M 10/625; H01M 10/613; B60L 58/26

(52) U.S. Cl. CPC H01M 10/6569; H01M 10/625; H01M 10/613; B60L 58/26; H01M 2220/20

(57) ABSTRACT

A battery cooling system for a battery pack includes an evaporator having an exterior surface arranged in contact with the battery pack, an inlet and an outlet. A condenser has an inlet and an outlet. A pump has an inlet and an outlet. A first conduit connects the outlet of the evaporator to an inlet of the condenser. A second conduit connects the outlet of the condenser to the inlet of the pump. A third conduit connects the outlet of the pump to the inlet of the condenser. A fan is arranged adjacent to the condenser. During operation, a first refrigerant flows through a coolant loop passing through the evaporator, the first conduit, the condenser, the second conduit, the pump and the third conduit. During normal charge and discharge operation, liquid phase cooling is performed and during fast charge and discharge operation, flow boiling is performed.

### CROSS-REFERENCE TO RELATED APPLICATIONS

This application claims the benefit of U.S. Provisional Application No. 63/131,450, filed on Dec. 29, 2020. The entire disclosure of the application referenced above is incorporated herein by reference.

### FIELD

The present disclosure relates to battery cooling systems and more particularly to battery cooling systems for vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Hybrid and electric vehicles typically include an electric motor/generator and one or more battery packs that provide drive propulsion. During driving, the battery packs are discharged although some recharging of the battery packs may occur during regenerative braking. The limited range and relatively long recharging period of the battery packs has slowed widespread adoption of electric vehicles. In other words, once the battery pack of the electric vehicle is drained, recharging the battery pack can take from a few hours to half of a day. Recharging is inconvenient for drivers who need to continue operating the vehicle despite the low battery charge state. This characteristic of battery-powered vehicles has caused consumers to have range anxiety due to the limited range of electric vehicles and the time required to recharge. In contrast, vehicles with combustion engines can be refueled within minutes and therefore are considered to have a relatively unlimited range.

To alleviate range anxiety, manufacturers are attempting to implement fast battery charging systems to improve the utility of battery powered vehicles. During fast charging, the battery packs are charged at higher power levels during a shorter period (less than one hour) to full or close to full charge states (e.g. 80%). During fast charging, the temperature of the battery packs can increase to temperatures that exceed recommended battery operating temperatures, which reduces the life of battery cells.

Some battery charging systems have battery cooling systems that control the temperature of the battery packs. For example, conventional heating, ventilation and cooling (HVAC) systems have been used to provide cooling during fast charging. However, these types of battery cooling systems require a compressor, an expansion valve and high-pressure connecting lines. As a result, these cooling systems tend to have relatively high weight, high noise, vibration and harshness (NVH) levels (due to compressor noise), high cost and/or low efficiency. These types of battery cooling systems are designed for a different problem (cooling the passenger compartment) and are not usually optimized for cooling battery packs.

### SUMMARY

A battery cooling system for a battery pack includes an evaporator having a first body including an exterior surface arranged in contact with the battery pack and a first channel including an inlet and an outlet. A condenser includes a second body with a second channel having an inlet and an outlet. A pump has an inlet and an outlet. A first conduit connects the outlet of the evaporator to an inlet of the condenser. A second conduit connects the outlet of the condenser to the inlet of the pump. A third conduit connects the outlet of the pump to the inlet of the condenser. A fan is arranged adjacent to the condenser. During operation, a first refrigerant flows through a coolant loop passing through the first channel of the evaporator, the first conduit, the second channel of the condenser, the second conduit, the pump and the third conduit. During normal charge and discharge operation, liquid phase cooling is performed in the coolant loop and the first refrigerant between the evaporator and the condenser is in a liquid state. During fast charge and discharge operation, flow boiling is performed in the coolant loop and the first refrigerant between the evaporator and the condenser is in a liquid and vapor state.

In other features, the first refrigerant flowing through the battery cooling system has a boiling temperature in a range from 30° C. to 55° C. A pressure in the coolant loop is below 25 psi during both normal operation and fast charge operation. The battery cooling system does not include a compressor connected between the evaporator and the condenser. The battery cooling system does not include an expansion valve connected between the condenser and the evaporator.

In other features, the first refrigerant has a boiling temperature at atmospheric pressure in a range from 35° C. to 50° C. A heat exchanger provides auxiliary cooling and includes a body defining a first flow path and a second flow path. The first flow path is connected to the second conduit. The second flow path receives a second refrigerant from an auxiliary refrigerant loop of a heating, ventilation and conditioning system.

In other features, the first refrigerant has a boiling temperature in a range from 30° C. to 55° C. The second refrigerant flowing through the second flow path has a boiling temperature less than 0° C. A temperature sensor is configured to sense a temperature of ambient air. A valve is configured to control flow of a second refrigerant through the auxiliary refrigerant loop. A controller is configured to control the valve to selectively perform auxiliary cooling of the coolant loop based on the sensed temperature.

In other features, at least one of a temperature sensor senses a temperature of the first refrigerant in the coolant loop and a pressure sensor senses a pressure of the first refrigerant in the coolant loop. A controller is configured to adjust a speed of the fan in response to at least one of the sensed temperature and the sensed pressure. A controller is configured to adjust a speed of the pump in response to at least one of the sensed temperature and the sensed pressure. The battery pack includes a side surface and the evaporator is arranged in contact with the side surface.

In other features, the battery pack includes a top surface and the evaporator is arranged in contact with the top surface. The battery pack includes a bottom surface and the evaporator is arranged in contact with the bottom surface.

In other features, a first temperature sensor is configured to sense a first temperature of the coolant loop at an outlet of the condenser. A first pressure sensor is configured to sense a first pressure of the coolant loop at the outlet of the condenser. A controller is configured to adjust a speed of the fan in response to the first temperature and the first pressure.

In other features, a first temperature sensor is configured to sense a first temperature of the coolant loop at an outlet of the evaporator. A first pressure sensor is configured to sense a first pressure of the coolant loop at the outlet of the evaporator. A controller is configured to adjust a speed of the pump in response to the first temperature and the first pressure.

In other features, a first temperature sensor is configured to sense a first temperature of the coolant loop at an outlet of the condenser. A first pressure sensor is configured to sense a first pressure of the coolant loop at the outlet of the condenser. A second temperature sensor is configured to sense a second temperature of the coolant loop at an outlet of the evaporator. A second pressure sensor is configured to sense a second pressure of the coolant loop at the outlet of the evaporator. A controller is configured to adjust a speed of the fan in response to the first temperature and the first pressure and to adjust a speed of the pump in response to the first temperature and the first pressure.

In other features, a reservoir is arranged between the outlet of the condenser and the pump. The controller is configured to selectively turn off the fan when the sensed temperature is greater than a temperature of the first refrigerant. The controller is configured to disable fast charging when the sensed temperature is greater than a temperature of the first refrigerant. The controller is configured to limit fast charging when the sensed temperature is greater than a temperature of the first refrigerant.

A battery cooling system for a battery pack includes an evaporator having an exterior surface arranged in contact with the battery pack and a first channel including an inlet and an outlet. A condenser has a second channel including an inlet and an outlet. A pump has an inlet and an outlet. A first conduit connects the outlet of the evaporator to an inlet of the condenser. A second conduit connects the outlet of the condenser to the inlet of the pump. A third conduit connects the outlet of the pump to the inlet of the condenser. A fan is arranged adjacent to the condenser. During operation, a first refrigerant flows through a coolant loop passing through the first channel of the evaporator, the first conduit, the second channel of the condenser, the second conduit, the pump and the third conduit. The first refrigerant flowing through the battery cooling system has a boiling temperature in a range from 30° C. to 55° C.

A battery cooling system for a battery pack includes an evaporator having an exterior surface arranged in contact with the battery pack and a first channel including an inlet and an outlet. A condenser has a second channel including an inlet and an outlet. A pump has an inlet and an outlet. A first conduit connects the outlet of the evaporator to an inlet of the condenser. A second conduit connects the outlet of the condenser to the inlet of the pump. A third conduit connects the outlet of the pump to the inlet of the condenser. A fan is arranged adjacent to the condenser. During operation, a first refrigerant flows through a coolant loop passing through the first channel of the evaporator, the first conduit, the second channel of the condenser, the second conduit, the pump and the third conduit. A pressure in the coolant loop is below 25 psi during both normal operation and fast charge operation.

A battery cooling system for a battery pack includes an evaporator having an exterior surface arranged in contact with the battery pack and a first channel including an inlet and an outlet. A condenser has a second channel including an inlet and an outlet. A pump has an inlet and an outlet. A first conduit connects the outlet of the evaporator to an inlet of the condenser. A second conduit connects the outlet of the condenser to the inlet of the pump. A third conduit connects the outlet of the pump to the inlet of the condenser. A fan is arranged adjacent to the condenser. During operation, a first refrigerant flows through a coolant loop passing through the first channel of the evaporator, the first conduit, the second channel of the condenser, the second conduit, the pump and the third conduit. The battery cooling system does not include a compressor connected between the evaporator and the condenser.

A battery cooling system for a battery pack includes an evaporator having an exterior surface arranged in contact with the battery pack and a first channel including an inlet and an outlet. A condenser has a second channel including an inlet and an outlet. A pump has an inlet and an outlet. A first conduit connects the outlet of the evaporator to an inlet of the condenser. A second conduit connects the outlet of the condenser to the inlet of the pump. A third conduit connects the outlet of the pump to the inlet of the condenser. A fan is arranged adjacent to the condenser. During operation, a first refrigerant flows through a coolant loop passing through the first channel of the evaporator, the first conduit, the second channel of the condenser, the second conduit, the pump and the third conduit. The battery cooling system does not include an expansion valve connected between the outlet of the condenser and inlet of the evaporator.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a cooling system using a compressor and performing expansion/compression of refrigerant according to the prior art;

FIG. 2 is a functional block diagram of a battery cooling system using a compressor and performing expansion/compression of refrigerant according to the prior art;

FIG. 3A is a functional block diagram of an example of a vehicle including a battery pack and a battery cooling system without a compressor according to the present disclosure;

FIG. 3B is a more detailed functional block diagram of an example of the battery cooling system of FIG. 3A according to the present disclosure;

FIG. 4A is a functional block diagram of the battery cooling system of FIG. 3A identifying various locations of the refrigerant during cooling of the battery pack according to the present disclosure;

FIG. 4B is a graph illustrating an example of the temperature of the battery and the refrigerant at the various locations depicted in FIG. 4A according to the present disclosure;

FIG. 5A is a functional block diagram of an example of a battery cooling system using auxiliary cooling from an HVAC system when the vehicle is operated in high ambient temperature according to the present disclosure;

FIG. 5B is a flowchart illustrating an example of a method for providing auxiliary cooling in the battery cooling system according to the present disclosure;

FIG. 6 is a functional block diagram of another example of a battery cooling system using auxiliary cooling from an HVAC system according to the present disclosure;

FIG. 7A is a functional block diagram of another example of a battery cooling system including a temperature sensor and a variable speed pump and/or a variable speed fan according to the present disclosure;

FIG. 7B is a flowchart illustrating an example of a method for operating the battery cooling system with the variable speed pump according to the present disclosure;

FIG. 8 is a functional block diagram of another example of a battery cooling system with the evaporator arranged on a top surface of the battery pack according to the present disclosure;

FIG. 9 is a functional block diagram of another example of a battery cooling system with the evaporator arranged on a bottom surface of the battery pack according to the present disclosure;

FIG. 10A is a functional block diagram of another example of a battery cooling system including temperature and pressure sensors, a variable speed pump and/or a variable speed fan according to the present disclosure; and

FIG. 10B is a flowchart illustrating an example of a method for operating the battery cooling system with the variable speed pump and/or the variable speed fan according to the present disclosure.

In the drawings, reference numbers may be reused to identify similar and/or identical elements.

### DETAILED DESCRIPTION

A battery cooling system according to the present disclosure enables fast charging (and discharging) without a compressor, throttle valve or high pressure refrigerant lines. Fast charging refers to charging the battery pack at higher power levels over a shorter duration (typically less than 1 hour (e.g. 5, 10, 15, 20 or 25 minutes)) to full capacity or lower capacities (such as greater than 30%, 40%, 50%, 60%, 70%, 80% or 90% charge states). Examples of fast discharging include operating the vehicle for relatively long durations at high loads (such as racing the vehicle, towing a trailer, or ascending a mountain) that cause the refrigerant to boil.

The battery cooling system according to the present disclosure uses two modes of cooling using refrigerant (forced liquid convection and boiling). The battery cooling system adapts to current heat loads. Forced liquid convection is used for cooling the battery pack during normal heat loads of the battery pack. Boiling of the refrigerant happens when high heat loads occur during fast charging or fast discharging.

Transitioning from forced liquid convection cooling to boiling heat cooling provides about 3× to more than 10× the cooling power of forced liquid convection cooling. Therefore, boiling cooling can accommodate the increased heat loads during fast charge or fast discharge. Two phase flow boiling cooling occurs at near constant temperature as compared to forced convection air cooled or forced convection liquid cooled systems. In this manner, the system is not over designed for normal operation like compressor-based refrigerant systems such as classic expansion/compression HVAC systems and/or refrigerant-based heat pump systems in order to accommodate fast charge or fast discharge events.

Since the compressor is no longer required, the battery cooling system according to the present disclosure does not have the relatively high noise, vibration and harshness (NVH) or the low efficiency of compressor-based systems. The battery cooling system also weighs less than the compressor-based systems. The compressor and throttle valve can be eliminated because the refrigerant has a relatively high boiling temperature (e.g. 45° C. or 115° F.) that can usually reject heat to ambient air temperature. However, the refrigerant may not be hot enough to reject heat to ambient air temperatures, which can exceed 45° C. in some geographic locations.

In some examples, the battery cooling system according to the present disclosure uses a refrigerant having a higher boiling temperature at atmospheric pressure than refrigerant that is typically used in compressor-based HVAC systems. For example, the battery cooling system according to the present disclosure may use a refrigerant having a boiling point in a range from 30° C. to 55° C. In other examples, the refrigerant has a boiling temperature at atmospheric pressure in a range from 35° C. to 50° C. In some examples, the refrigerant includes 3M Novec refrigerant.

Typical HVAC refrigerants (such as R134a) have a boiling temperature that is much lower at ambient pressure (e.g. typically lower than 0° C.). For example, R134a boils at −15° C. at atmospheric pressure. R134a is compressed to 8× to 10× atmospheric pressure to raise the boiling temperature to about 30° C. so the refrigerant can reject heat to outdoor ambient temperatures. The refrigerant is then throttled to reduce the pressure and temperature to −15° C. so that the temperature is low enough to cool passengers (about 4° C. or 40° F. air temperature). While these temperatures are consistent with air conditioning applications, batteries such as Li-Ion batteries do not need to be cooled to 4° C. Rather, these batteries should be cooled below about 50° C. or 60° C. depending on chemistry and the desired cell life.

The evaporator includes a body including an exterior surface arranged in contact with the battery pack. A channel passes through the first body and includes an inlet and an outlet. As can be appreciated, the refrigerant passes through the channel and is heated (or cooled) by the body of the evaporator without directly contacting the battery pack (unlike immersion-based systems where the battery pack is immersed in refrigerant). Likewise, the condenser includes a body with a channel including an inlet and an outlet.

In some examples, interior surfaces of refrigerant channels in the evaporator (also sometimes referred to as a cooling plate or battery cell interface) have enhanced nucleation surfaces that can be used to minimize the temperature difference between the evaporator and the boiling point of the high temperature refrigerant from about 10° C. to less than 2° C. In some examples, the enhanced nucleation surfaces provide an increased exposed surface area. In some examples, the enhanced nucleation surfaces include porous surfaces with increased surface area. In other examples, the enhanced nucleation surfaces includes sharp portions that project inwardly and are arranged in random or patterned locations. In some examples, the sharp portions are made of diamond dust particles, sintered metal powders, etc. During use, bubbles form more easily (and with a lot less energy) on porous surfaces and/or sharp points as compared to smooth surfaces. As a result, boiling starts when the surface temperature is only a couple of degrees above the fluid boiling temp (instead of at higher dT such as 10° C. dT or so for smooth surfaces). This provides even more temperature difference for the high temperature refrigerant to reject heat to the outside ambient temperature. In some examples, if outside ambient temperature is above 45° C., the heat could also be rejected to an auxiliary refrigerant cooling loop of an HVAC system (which operates at about −15° C.).

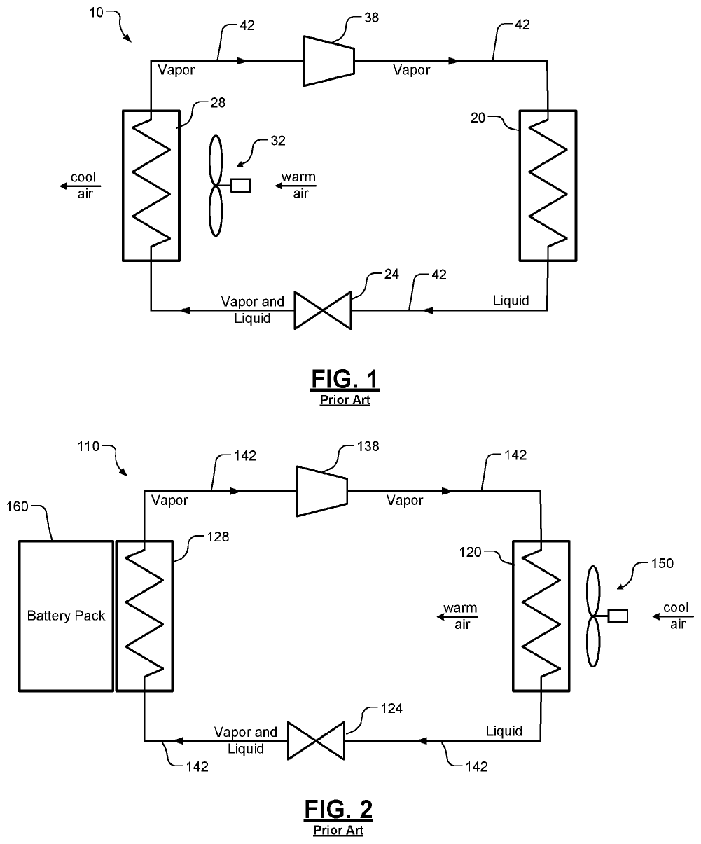

Referring now to FIG. 1, a cooling system 10 using a compressor and performing expansion/compression of refrigerant is shown to include a condenser 20, an expansion valve 24, an evaporator 28 and a compressor 38. A fan 32 may be used to direct warm air across the evaporator 28. Some of the refrigerant absorbs the heat and transitions to vapor. The vapor is compressed by the compressor 38, which increases the temperature (typically above ambient) and pressure of the refrigerant. The vapor output by the compressor 38 is supplied to the condenser 20. The refrigerant in the condenser 20 exchanges heat with the surrounding air and condenses to liquid refrigerant. The refrigerant flows to the expansion valve 24, which outputs vapor and liquid refrigerant to the evaporator 28. The cycle is repeated to provide continuous cooling. In this example, the warm air supplied by the fan 32 may be ambient outside air that is cooled by the evaporator 28 to reduce the temperature inside the cabin of a vehicle.

Given the high pressures that are used, the refrigerant flows through high-pressure conduit 42 connecting the components of the cooling system 10 together. In some examples, the refrigerant in the conduit 42 have pressures in a range from greater than about 30 pounds per square inch (psi) on the low pressure side (before the compressor 38) to over 100 psi on the high pressure side (after the compressor 38).

Referring now to FIG. 2, a cooling system 110 (that is similar to the cooling system 10) may be used to cool a battery pack. The cooling system 110 includes a condenser 120, an expansion valve 124, an evaporator 128, and a compressor 138. Conduit 142 capable of handling high pressure refrigerant connects the condenser 120, the expansion valve 124, the evaporator 128, and the compressor 138 to form a coolant loop. A fan 150 may be used to direct cool air across the condenser 120 to increase cooling. A battery pack 160 includes one or more battery modules and/or one or more battery cells. The battery pack 160 is arranged in close proximity to (and/or in direct contact with) a surface of the evaporator 128 to allow heat exchange therebetween.

Heat from the battery pack 160 is absorbed by the refrigerant in the evaporator 128, which may cause some of the refrigerant to transition to vapor. In this example, the air supplied by the fan 150 is cool ambient air that is heated by refrigerant in the evaporator 128 causing the refrigerant to transition from vapor to liquid.

The cooling systems in FIGS. 1 and 2 have relatively high cost, high weight, high noise, vibration and harshness (NVH) levels, and/or are generally inefficient. In addition, these types of HVAC systems are designed for a different problem (cooling the passenger compartment) and are not optimized for cooling battery packs. The NVH is particularly noticeable in electric vehicles where the powertrain is relatively quiet and the noise becomes noticeable to occupants.

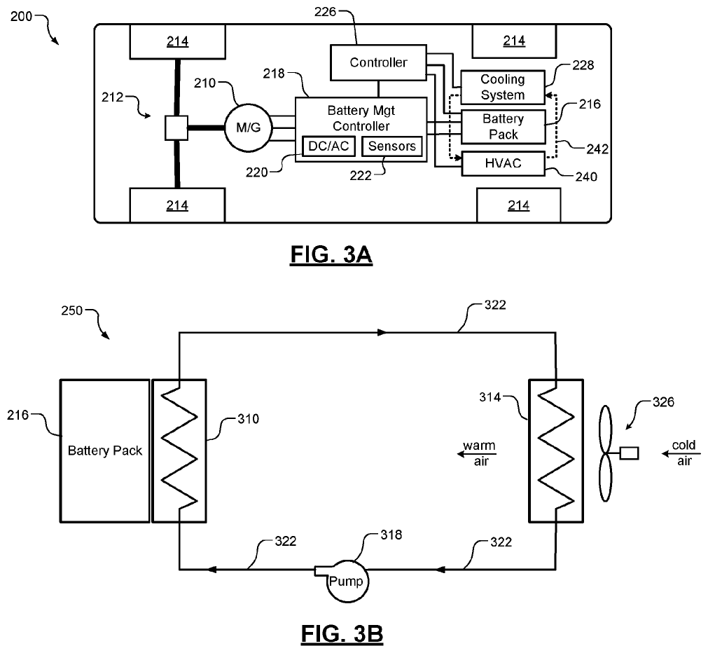

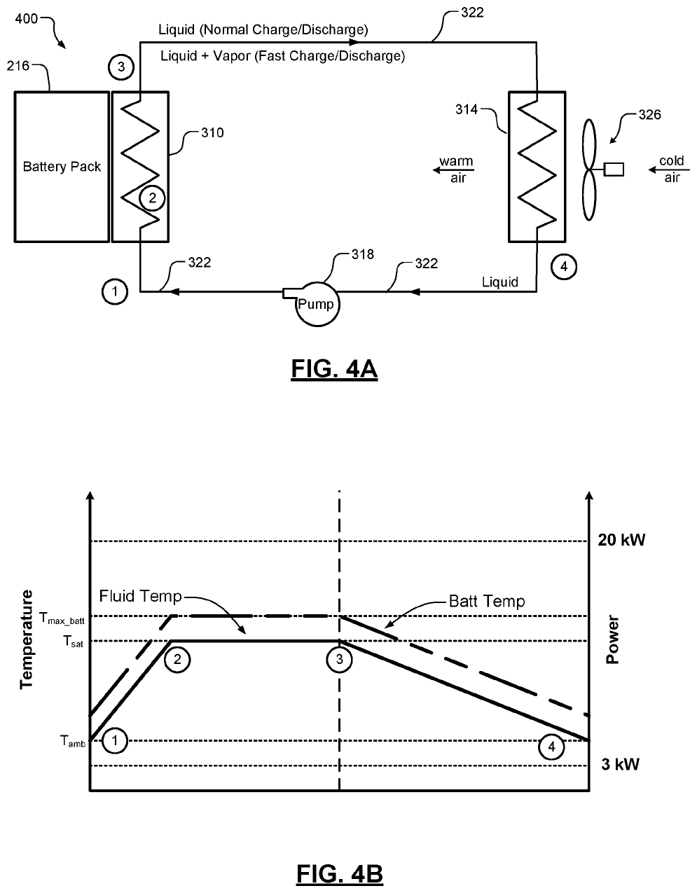

Referring now to FIG. 3A, a vehicle 200 is shown to include a drivetrain including a motor/generator 210, a rear axle assembly 212 and wheels 214. A battery pack 216 includes series and/or parallel connected battery sub-packs each with one or more battery cells. Power from the battery pack 216 is supplied by a battery management controller 218 to the motor/generator 210 based upon input from an operator. The battery management controller 218 typically includes and/or controls a DC/AC converter 220 based on input from one or more sensors 222 such as temperature, current, voltage and/or other types of sensors. The battery management controller 218 may communicate with a vehicle controller 226 that receives the input from the operator.

The battery pack 216 is cooled by a battery cooling system 228 that employs liquid phase cooling during normal charge and discharge operation and flow boiling during fast battery charge and discharge operation as will be described further below. In some examples, a vehicle HVAC system 240 provides auxiliary cooling using an auxiliary cooling loop 242 supplying cooled refrigerant to the battery cooling system 228 under some circumstances described further below.

Referring now to FIG. 3B, a battery cooling system 250 that uses liquid cooling during normal charge and discharge operation and flow boiling during fast charge and discharge operation according to the present disclosure is shown. The battery cooling system 250 includes an evaporator 310 that is arranged adjacent to (and/or in direct contact with) at least one surface of the battery pack 216 to allow heat exchange therebetween. A condenser 314 is fluidly connected by a conduit 322 to an evaporator 310. The condenser 314 is connected by a conduit 322 to a pump 318, which is connected by a conduit 322 to the evaporator 310. A fan 326 may be used to blow ambient air across the condenser 314. The fan 326 may be a fixed speed fan or a variable speed fan.

The battery cooling system 250 operates near atmospheric pressure since there is only pumping of liquid and no compression of vapor. In some examples, the refrigerant that is selected has a boiling temperature (at or near atmospheric pressure) this is below the maximum cell temperature. The amount of temperature difference (below maximum cell temperature) is determined by the cell or vehicle manufacturer. The temperature involves a trade-off between cell life (cell life is typically better at lower temperatures) and performance (performance is typically better at higher temperatures (lower resistance, more power for charging or discharging for longer periods of time)).

Enhanced nucleation surfaces reduces the required temperature difference (dT) between the fluid and the battery cell interface before boiling occurs so the boiling point of the refrigerant can be closer to the maximum cell temperature. This also allows more dT between the boiling point of the refrigerant and the outside ambient, making it easier to condense the refrigerant vapor by rejecting the heat to ambient (because the boiling/condensing temperature is higher).

For example only, most battery cells have a maximum temperature of 50° C. (for example, lithium iron phosphate (LFP)) or 60° C. (nickel manganese cobalt (NMC). The life of the battery cells decreases dramatically above these temperatures. For some batteries, the cycle life (corresponding to the number of charge/discharge cycles) halves for about every 10° C. increase in temperature in the normal operating range. In some examples, the refrigerant used in the battery cooling system 250 has a boiling point of about 45° C. for LFP cells for performance vehicles and about 35° C. for “long life” vehicles (fleets or conservative cars). In another example, a refrigerant with a boiling point of about 55° C. is used for NMC cells for performance vehicles and about 45° C. for “long life” vehicles (fleets or conservative cars).

The refrigerant flowing through the conduit 322 does not need to be compressed by a compressor or expanded by an expansion valve. As a result, the conduit 322 does not need to withstand high pressure.

In some examples, the pressure within the conduit 322 is below 25 psi, which is lower than the low pressure side and significantly lower than the high pressure side of the compressor-based HVAC systems shown in FIGS. 1 and 2. In other examples, the pressure within conduit 322 is below 20 psi or less than atmospheric pressure at a given location plus 5 psi or 10 psi. Generally, the pressure in the conduit will be elevated by the pump and/or increased due to heating of the refrigerant to vapor.

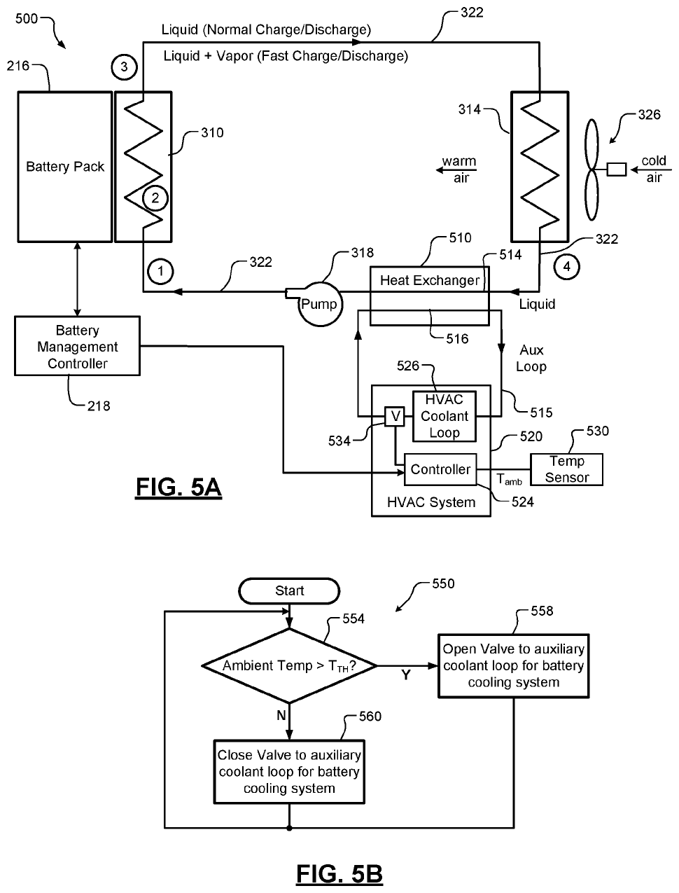

Referring now to FIGS. 4A and 4B, the battery cooling system 400 is shown in further detail. The refrigerant that is output by the pump 318 in a liquid state flows to an inlet of the evaporator 310, which is being heated by the battery pack 216. Heat from the battery pack 216 heats the refrigerant thereby cooling the battery pack 216.

During normal charge and discharge operation, heat from the battery pack 216 can typically be absorbed by the liquid refrigerant with little or no phase change to vapor. The refrigerant flows through the conduit 322 to the condenser and is cooled by the cool ambient air directed by the fan 326 across the condenser 314. The cooled liquid refrigerant is output to the pump 318 and the cycle repeats.

During fast charging and discharging operation, heat from the battery pack 216 increases significantly. The increased heat is absorbed by the refrigerant and some of the refrigerant in the evaporator 310 transitions to the vapor state. The relative amounts of vapor and liquid exiting the evaporator 310 will depend on the heat load. The liquid and vapor refrigerant flows through the conduit 322 to the condenser 314. The liquid and vapor refrigerant is cooled by the cool ambient air directed by the fan 326 across the condenser 314, the vapor condenses into liquid and/or the liquid refrigerant is cooled. The cooled liquid refrigerant is output to the pump 318 and the cycle repeats.

In FIG. 4B, the refrigerant temperature is shown during a fast charge or discharge event. As the heat produced by the battery pack increases during the recharge event, the heat is absorbed by the refrigerant, the temperature of the refrigerant increases and some or all of the refrigerant boils. Eventually, the refrigerant reaches a saturation temperature Tₛₐₜ. The refrigerant flows through the condenser 314 and the refrigerant is cooled. The temperature of the refrigerant decreases below Tₛₐₜ after the fast charge or discharge event ends.

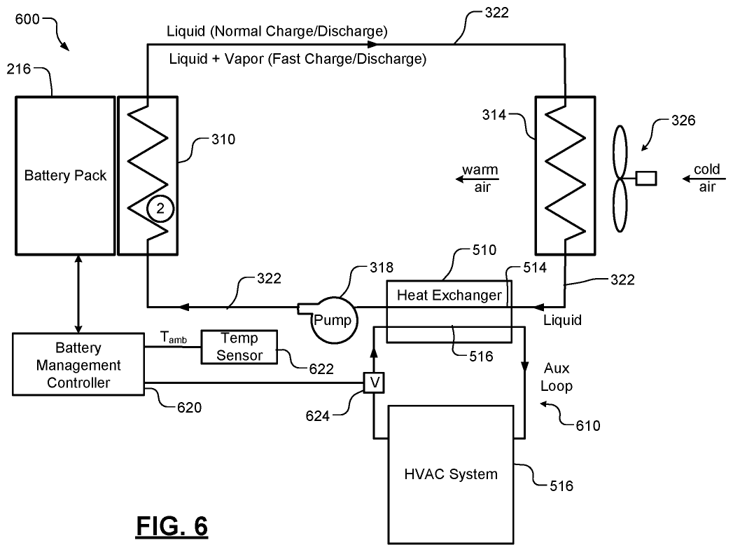

Referring now to FIG. 5A, another cooling system 500 for the battery pack 216 is shown. In some examples, the vehicle may be driven in locations such as desert areas that experience higher ambient temperatures that may be greater than the boiling temperature of the refrigerant. As a result, the condenser 314 may not be able to cool the refrigerant (since it is hotter than the refrigerant). In some examples, when the ambient temperature is greater than the refrigerant temperature, the fan is turned off to prevent further heating of the refrigerant and auxiliary cooling is performed. In some examples, fast charging may be limited (for example to charge states of 10%, 15%, 20%) (with or without auxiliary cooling) or disabled (when no auxiliary cooling is used) when the ambient temperature is greater than the boiling temperature of the refrigerant.

In some examples, auxiliary cooling may be provided by an HVAC system of the vehicle. For example, the conduit 322 located between the condenser 314 and the pump 318 passes through a first flow path 514 through a body of a heat exchanger 510. A vehicle HVAC system 520 includes a coolant loop 526 and a controller 524. The controller 524 communicates with a temperature sensor 530 that monitors ambient temperature. Alternately, the ambient temperature can be measured by another vehicle system or estimated. When the ambient temperature exceeds a predetermined temperature, the controller 524 opens a valve 534 to provide refrigerant to an auxiliary coolant loop 515 connected to a second flow path 516 in the body of the heat exchanger passing through the heat exchanger 510. In some examples, the predetermined temperature that is used to trigger opening of the valve 534 is set less than or equal to Tₛₐₜ. When the valve 534 is opened, the cooled refrigerant flows through the second flow path 516 to cool refrigerant flowing through the first flow path 514 of the heat exchanger 510. While a manifold-style heat exchanged is shown, other heat exchangers can be used. For example, the conduits for the battery cooling system can be soldered to conduit for the auxiliary loop to allow heat exchange therebetween.

Referring now to FIG. 5B, a method 550 for controlling operation of the auxiliary cooling loop is shown. At 554, the ambient temperature is compared to a predetermined temperature threshold. If the ambient temperature is greater than the predetermined temperature threshold (as determined at 554), the valve 534 to the auxiliary coolant loop is opened for the battery cooling system at 558. The fan can also be turned off. If the ambient temperature is less than the predetermined temperature threshold, the valve 534 to the auxiliary coolant for the battery system is closed at 560. The fan can optionally be turned back on.

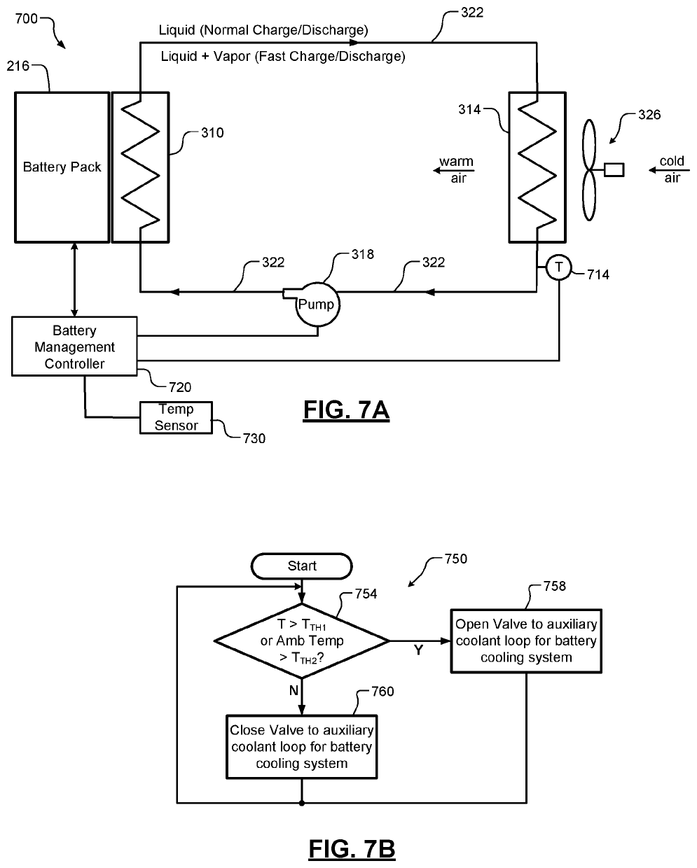

Referring now to FIG. 6, an alternate cooling system 600 that uses an auxiliary cooling loop is shown. In this example, a battery management controller 620 monitors a temperature sensor 622. As described above, when the ambient temperature measured by the temperature sensor 622 is greater than a first predetermined temperature threshold, the battery management controller 620 opens a valve 624 to supply refrigerant to the second flow path 516 of the heat exchanger 510. When the ambient temperature measured by the temperature sensor 622 is less than a second predetermined temperature threshold, the battery management controller 620 opens a valve 624 to supply refrigerant to the second flow path 516 of the heat exchanger 510. The first and second temperature thresholds can be the same or different (to provide hysteresis).

Referring now to FIG. 7A, another battery cooling system 700 is shown to include a battery management controller 720 connected to a temperature sensor 714 measuring a temperature of fluid exiting the condenser 314. Alternately or additionally, the temperature also be monitored at the outlet of the evaporator 310.

When the temperature of the fluid exiting the condenser is greater than a predetermined temperature threshold, the battery management controller 720 adjusts a speed of the pump 318. For example, the battery management controller 720 increases a speed of the pump 318 when the temperature of the fluid exiting the condenser (or evaporator) is greater than the predetermined temperature threshold. In other examples, the battery management controller 720 adjusts the speed of the pump 318 based on the ambient temperature measured by a temperature sensor 730 as described above.

Referring now to FIG. 7B, a method 750 for controlling the pump 318 is shown. At 754, the method determines whether the temperature of the fluid exiting the evaporator 310 is greater than a first temperature threshold or the ambient temperature is greater than a second temperature threshold. If either condition is true, the method proceeds to 758 and increases a speed of the pump 318 (and/or opens the valve to the auxiliary coolant loop as described above). If 754 is false, the method proceeds to 760 and decreases the speed of the pump 318 (and/or closes the valve to the auxiliary coolant as described above). As described above, different temperature thresholds can be used to close the valves to provide hysteresis.

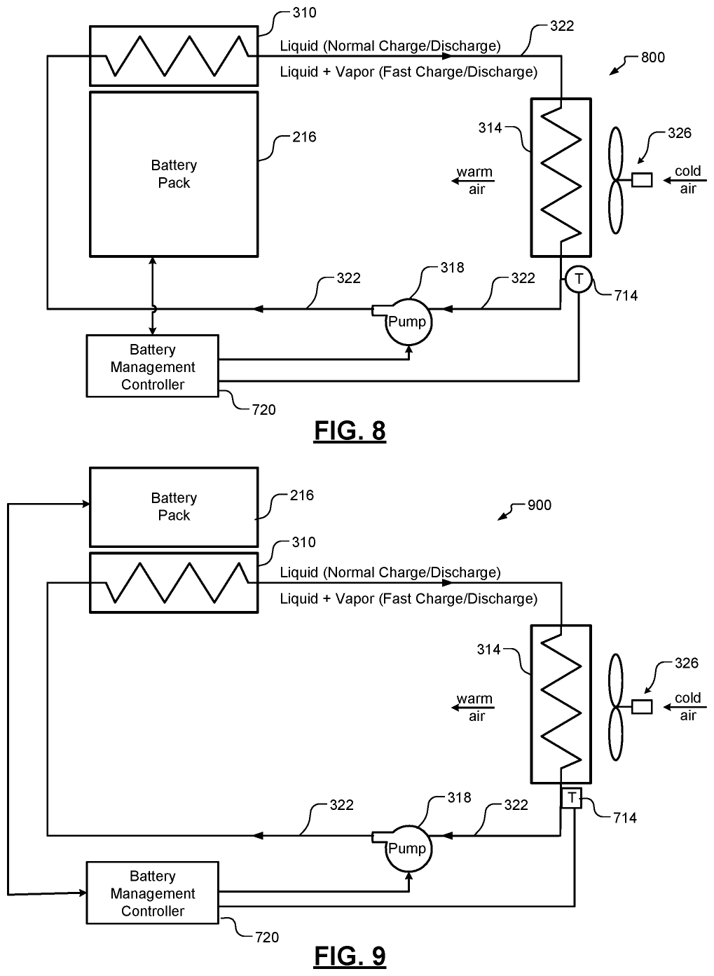

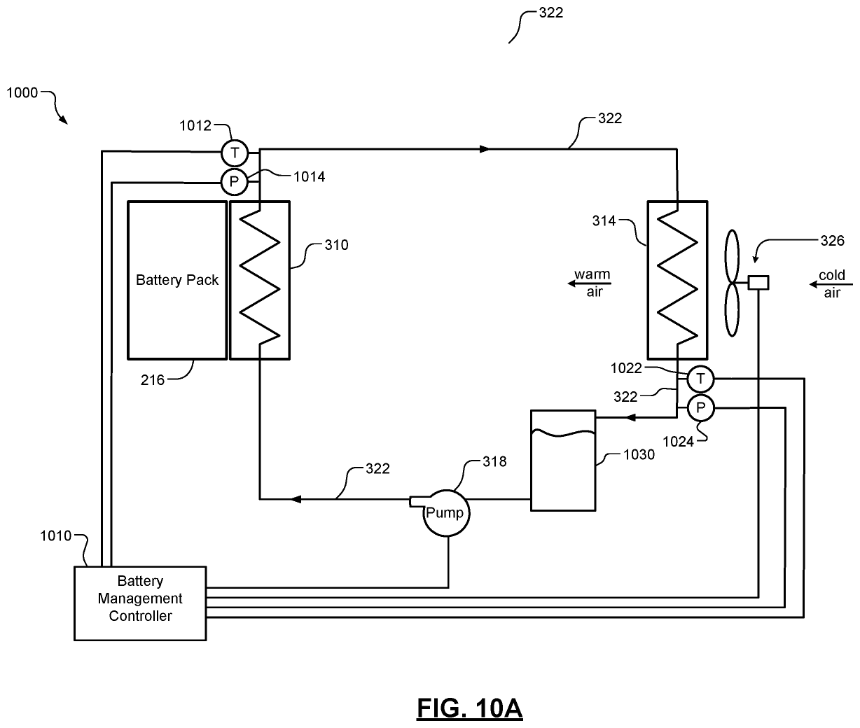

Referring now to FIGS. 8 and 9, while the preceding examples showed the evaporator 310 arranged vertically adjacent to and/or in direct contact with a vertical side wall of the battery pack 216, the evaporator 310 can be arranged in various other locations relative to the battery pack 216. For example, in FIG. 8, the evaporator 310 is arranged adjacent to and/or in direct contact with a top surface of the battery pack 216. This configuration has the advantage that the liquid refrigerant will tend to be on a bottom surface of the flow passages passing through the evaporator 310 (and closer to the heated battery pack) and the vapor refrigerant (if present) will be adjacent to an upper surface of the conduit. In FIG. 9, the evaporator 310 is arranged immediately adjacent to and/or contact with a bottom surface of the battery pack 216.

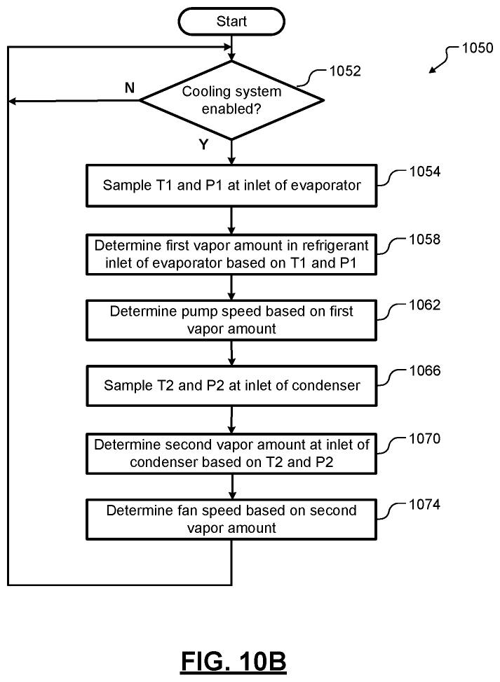

Referring now to FIGS. 10A and 10B, a battery cooling system 1000 includes temperature and pressure sensors 1012 and 1014 at an outlet of the evaporator 310 and temperature and pressure sensors 1022 and 1024 at an outlet of the condenser 314. The temperature and pressure sensors 1012 and 1014 and temperature and pressure sensors 1022 and 1024 are used to characterize the state of the refrigerant at the outlet of the evaporator 310 and the condenser 314, respectively.

The sensed pressure and temperature values at the inlet of the evaporator are used by the battery management controller 1010 to determine vapor content of the refrigerant and to adjust a speed of the pump to increase or decrease supply of refrigerant (at the expense of increased pump power consumption). The sensed pressure and temperature values at the inlet of the condenser are used by the battery management controller 1010 to determine vapor content of the refrigerant and to adjust a speed of the fan 326 to increase or decrease cooling (at the expense of increased fan power consumption). A reservoir 1030 may be used to store refrigerant, to accumulate vapor during transitory events and to accommodate different vapor levels. While both fan speed and pump speed are controlled in this example, either can be used alone and/or used in conjunction with other types of control.

Referring now to FIG. 10B, a method 1050 for operating the battery cooling system of FIG. 10A is shown. When the battery cooling system is enabled as determined at 1052, the method samples T1 and P1 at the outlet of the evaporator at 1054. At 1058, the method determines a first vapor amount in the refrigerant based on T1 and P1. At 1062, the method determines the pump speed based on the first vapor amount.

At 1066, the method samples T2 and P2 at the outlet of the condenser at 1066. At 1070, the method determines a second vapor amount in the refrigerant at the outlet of the condenser based on T2 and P2. At 1074, the method determines the fan speed based on the second vapor amount.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A battery cooling system for a battery pack, comprising:
an evaporator having a first body including an exterior surface arranged adjacent to the battery pack and a first channel passing through the first body and including an inlet and an outlet;
a condenser including a second body with a second channel having an inlet and an outlet;
a pump having an inlet and an outlet;
a first conduit connecting the outlet of the evaporator to an inlet of the condenser;
a second conduit connecting the outlet of the condenser to the inlet of the pump;
a third conduit connecting the outlet of the pump to the inlet of the evaporator;
a fan arranged adjacent to the condenser; and
a first refrigerant configured to flow through a coolant loop passing through the first channel of the evaporator, the first conduit, the second channel of the condenser, the second conduit, the pump and the third conduit;
wherein the first refrigerant between the evaporator and the condenser is in a liquid state during a first type of charge and discharge operation; and
wherein the first refrigerant between the evaporator and the condenser is in a liquid and vapor state during a second type of charge and discharge operation that is faster than the first type.

2. The battery cooling system of claim 1, wherein the first refrigerant flowing through the battery cooling system has a boiling temperature in a range from 30° C. to 55° C.

3. The battery cooling system of claim 1, wherein a pressure in the coolant loop is below 25 psi during both normal operation and fast charge operation.

4. The battery cooling system of claim 1, wherein the battery cooling system does not include a compressor connected between the evaporator and the condenser.

5. The battery cooling system of claim 1, wherein the battery cooling system does not include an expansion valve connected between the condenser and the evaporator.

6. The battery cooling system of claim 1, wherein the first refrigerant has a boiling temperature at atmospheric pressure in a range from 35° C. to 50° C.

7. The battery cooling system of claim 1, further comprising:
a heat exchanger to provide auxiliary cooling and including body defining a first flow path and a second flow path,
wherein the first flow path is connected to the second conduit, and
wherein the second flow path receives a second refrigerant from an auxiliary refrigerant loop of a heating, ventilation and conditioning system.

8. The battery cooling system of claim 7, wherein:
the first refrigerant has a boiling temperature in a range from 30° C. to 55° C.; and
the second refrigerant flowing through the second flow path has a boiling temperature less than 0° C.

9. The battery cooling system of claim 7, further comprising:
a temperature sensor configured to sense a temperature of ambient air;
a valve configured to control flow of the second refrigerant through the auxiliary refrigerant loop; and
a controller configured to control the valve to selectively perform auxiliary cooling of the coolant loop based on the sensed temperature.

10. The battery cooling system of claim 1, further comprising at least one of:
a temperature sensor to sense a temperature of the first refrigerant in the coolant loop; and
a pressure sensor to sense a pressure of the first refrigerant in the coolant loop.

11. The battery cooling system of claim 10, further comprising a controller configured to adjust a speed of the fan in response to at least one of the sensed temperature and the sensed pressure.

12. The battery cooling system of claim 10, further comprising a controller configured to adjust a speed of the pump in response to at least one of the sensed temperature and the sensed pressure.

13. The battery cooling system of claim 1, wherein the battery pack includes a side surface and wherein the evaporator is arranged in contact with the side surface.

14. The battery cooling system of claim 1, wherein the battery pack includes a top surface and wherein the evaporator is arranged in contact with the top surface.

15. The battery cooling system of claim 1, wherein the battery pack includes a bottom surface and wherein the evaporator is arranged in contact with the bottom surface.

16. The battery cooling system of claim 1, further comprising:
a first temperature sensor configured to sense a first temperature of the coolant loop at an outlet of the condenser;
a first pressure sensor configured to sense a first pressure of the coolant loop at the outlet of the condenser; and
a controller configured to adjust a speed of the fan in response to the first temperature and the first pressure.

17. The battery cooling system of claim 1, further comprising:
a first temperature sensor configured to sense a first temperature of the coolant loop at an outlet of the evaporator;
a first pressure sensor configured to sense a first pressure of the coolant loop at the outlet of the evaporator; and
a controller configured to adjust a speed of the pump in response to the first temperature and the first pressure.

18. The battery cooling system of claim 1, further comprising:
a first temperature sensor configured to sense a first temperature of the coolant loop at an outlet of the condenser;
a first pressure sensor configured to sense a first pressure of the coolant loop at the outlet of the condenser;
a second temperature sensor configured to sense a second temperature of the coolant loop at an outlet of the evaporator;
a second pressure sensor configured to sense a second pressure of the coolant loop at the outlet of the evaporator; and
a controller configured to adjust a speed of the fan in response to the first temperature and the first pressure and to adjust a speed of the pump in response to the first temperature and the first pressure.

19. The battery cooling system of claim 1, further comprising a reservoir arranged between the outlet of the condenser and the pump.

20. The battery cooling system of claim 9, wherein the controller is configured to selectively turn off the fan when the sensed temperature is greater than a temperature of the first refrigerant.

21. The battery cooling system of claim 9, wherein the controller is configured to disable fast charging when the sensed temperature is greater than a temperature of the first refrigerant.

22. The battery cooling system of claim 9, wherein the controller is configured to limit fast charging when the sensed temperature is greater than a temperature of the first refrigerant.

23. A battery cooling system for a battery pack, comprising:
an evaporator having an exterior surface arranged adjacent to the battery pack and a first channel including an inlet and an outlet;
a condenser having a second channel including an inlet and an outlet;
a pump having an inlet and an outlet;
a first conduit connecting the outlet of the evaporator to an inlet of the condenser;
a second conduit connecting the outlet of the condenser to the inlet of the pump;
a third conduit connecting the outlet of the pump to the inlet of the evaporator; and
a fan arranged adjacent to the condenser; and
a first refrigerant configured to flow through a coolant loop passing through the first channel of the evaporator, the first conduit, the second channel of the condenser, the second conduit, the pump and the third conduit,
wherein the first refrigerant flowing through the battery cooling system has a boiling temperature in a range from 30° C. to 55° C.

24. A battery cooling system for a battery pack, comprising:
an evaporator having a first body including an exterior surface arranged adjacent to the battery pack and a first channel passing through the first body and including an inlet and an outlet;
a condenser including a second body with a second channel an inlet and an outlet;
a pump having an inlet and an outlet;
a first conduit connecting the outlet of the evaporator to an inlet of the condenser;
a second conduit connecting the outlet of the condenser to the inlet of the pump;
a third conduit connecting the outlet of the pump to the inlet of the evaporator; and
a fan arranged adjacent to the condenser; and
a first refrigerant configured to flow through a coolant loop passing through the first channel of the evaporator, the first conduit, the second channel of the condenser, the second conduit, the pump and the third conduit,
wherein a pressure in the coolant loop is below 25 psi during both normal operation and fast charge operation.

25. A battery cooling system for a battery pack, comprising:
an evaporator having a first body including an exterior surface arranged adjacent to the battery pack and a first channel passing through the first body and including an inlet and an outlet;
a condenser including a second body with a second channel an inlet and an outlet;
a pump having an inlet and an outlet;
a first conduit connecting the outlet of the evaporator to an inlet of the condenser;
a second conduit connecting the outlet of the condenser to the inlet of the pump;
a third conduit connecting the outlet of the pump to the inlet of the evaporator; and
a fan arranged adjacent to the condenser; and
a first refrigerant configured to flow through a coolant loop passing through the first channel of the evaporator, the first conduit, the second channel of the condenser, the second conduit, the pump and the third conduit,
wherein the battery cooling system does not include a compressor connected between the evaporator and the condenser.

26. A battery cooling system for a battery pack, comprising:
an evaporator having a first body including an exterior surface arranged adjacent to the battery pack and a first channel passing through the first body and including an inlet and an outlet;
a condenser including a second body with a second channel an inlet and an outlet;
a pump having an inlet and an outlet;
a first conduit connecting the outlet of the evaporator to an inlet of the condenser;
a second conduit connecting the outlet of the condenser to the inlet of the pump;
a third conduit connecting the outlet of the pump to the inlet of the evaporator; and
a fan arranged adjacent to the condenser; and
a first refrigerant configured to flow through a coolant loop passing through the first channel of the evaporator, the first conduit, the second channel of the condenser, the second conduit, the pump and the third conduit,
wherein the battery cooling system does not include an expansion valve connected between the outlet of the condenser and inlet of the evaporator.
